(19) United States
(12) Patent Application Publication
(10) Pub. No.: US 2023/0034228 A1
(43) Pub. Date: Feb. 2, 2023

(54) FIXING AN ELEVATOR COMPONENT TO A SHAFT WALL

(71) Applicant: Inventio AG, Hergiswil (CH)

(72) Inventor: RENÉ STREBEL, Sarmenstorf (CH)

(21) Appl. No.: 17/756,565

(22) PCT Filed: Nov. 27, 2020
(86) PCT No.: PCT/EP2020/083577

§ 371 Date: May 27, 2022

(30) Foreign Application Priority Data
Dec. 5, 2019 (EP) 19213890.7

(51) Int. Cl. B66B 19/00; F16B 47/00; B66B 7/02

(52) U.S. Cl. CPC B66B 19/002; F16B 47/003; B66B 7/024

(57) ABSTRACT

A method for fixing a component to an elevator system shaft wall includes: prefixing the component to the shaft wall by a self-adhesive element attached or applied to a first part of a contact surface of the component; and applying a curing adhesive layer to a second part of the contact surface between the contact surface and a fixing region of the shaft wall. The component can be a rail bracket for fixing a guide rail of the elevator system wherein the component forms the contact surface for flat fixing of the component to the shaft wall, the self-adhesive element is arranged between the first part of the contact surface and the fixing region of the shaft wall and the adhesive layer is arranged in the second part of the contact surface in a fixed state of the component to the shaft wall.

### FIELD

The invention relates to a method for fixing a component to a shaft wall of an elevator shaft of an elevator system, in particular a rail bracket for fixing the guide rail, and to an elevator system having such a component fixed to the shaft wall.

### BACKGROUND

Conventional elevator systems comprise an elevator shaft and an elevator car. The elevator car can be moved in the opposite direction to a counterweight along the, for example vertically arranged, elevator shaft. Both the elevator car and the counterweight are usually each guided on two guide rails. Corresponding to the direction of movement, these guide rails are fixed along the elevator shaft on a shaft wall of the elevator shaft. In order to anchor this guide rail to the shaft wall, rail brackets are fixed directly to the shaft wall.

WO 2018/145984 describes a method for fixing such a rail bracket to a shaft wall of an elevator shaft. The guide rails are fixed to the shaft wall by means of the rail bracket. The rail bracket substantially consists of a rail bracket lower part and a rail bracket upper part, with the rail bracket lower part being glued to the shaft wall. Anchors or screws are used, for example, to prefix the rail bracket lower part to the shaft wall in order to prevent slippage during curing of an adhesive layer between the shaft wall and the rail bracket lower part. The disadvantage here is that such prefixing causes noise and dust from drilling holes into the shaft wall.

### SUMMARY

Therefore, an object of the invention is that of proposing a method for fixing a component, in particular a rail bracket, to the shaft wall, which simplifies the fixing of this component to the shaft wall.

This object is achieved by way of a method for fixing a component to a shaft wall of an elevator system, in particular a rail bracket to be fixed to the shaft wall, which rail bracket is suitable for fixing a guide rail inside the elevator system, wherein the component has a contact surface for flat fixing of the component to the shaft wall, the method comprising the following method steps:

prefixing the component to the shaft wall by means of a self-adhesive element to be attached or applied to a first part of the contact surface; and

applying an adhesive layer, provided for curing, to a second part of the contact surface, which adhesive layer is arranged between a contact surface of the component and a fixing region of the shaft wall in a fixed state of the component to the shaft wall.

The object is also achieved by means of an elevator system having a shaft wall and a component fixed to the shaft wall, which component is in particular designed as a rail bracket for fixing a guide rail of the elevator system, wherein the component forms a contact surface for flat fixing of the component to the shaft wall and the contact surface has two parts, wherein a self-adhesive element is arranged between the contact surface and a fixing region of the shaft wall in the first part of the contact surface and an adhesive layer is arranged in the second part of the contact surface in a fixed state of the component to the shaft wall.

The object is also achieved by a component, in particular a rail bracket for being fixed to a shaft wall of an elevator system, wherein the component forms a contact surface for flat fixing of the component to the shaft wall and the contact surface forms a first part for applying a self-adhesive element, which is suitable for prefixing to a shaft wall, and a second part for applying an adhesive, wherein the contact surface, in the second part thereof, has at least one through-hole in order to apply the adhesive and/or in order to visually monitor a space between the contact surface and the fixing region of the shaft wall.

The fixing region corresponds to the region of the shaft wall which is provided for directly accommodating the contact surface of the component by means of the fixing method according to the invention. The contact surface of the component is divided into mainly two parts. The first part of the contact surface is provided with a self-adhesive element for prefixing. On the one hand, this can mean that the component to be attached to the shaft wall is provided with the self-adhesive element in advance and accordingly has the self-adhesive element. On the other hand, the fixing region can be provided with the self-adhesive element in advance in such a way that when the component is attached to the shaft wall for prefixing, the self-adhesive element is arranged on the first part of the contact surface and is accordingly not a constituent of the component, in particular the rail bracket, in advance.

Such a self-adhesive element can be formed, for example, by a material layer, which material layer is adhesive on both sides or adheres to the shaft wall or to the first part of the contact surface of the component to be fixed. Examples are double-sided adhesive tapes of different strengths or thicknesses.

The second part is provided with an adhesive layer which is provided for curing. When attaching the component to the preferably prepared or primed shaft wall, in particular to the prepared or primed fixing region of the shaft wall, the component adheres thereto by means of the self-adhesive element. However, the self-adhesive element alone is not sufficient to keep the component of the elevator system on the shaft wall in accordance with the loads on the component that occur during operation of the elevator system. Accordingly, the adhesive layer has to harden in order to keep the component fixed to the shaft wall during operation of the elevator system.

The self-adhesive element and/or the adhesive forming the adhesive layer can be selected in such a way that vibrations of the component, which vibrations are caused, for example, by the operation of the elevator system, are not transmitted to the shaft wall, or are transmitted to the shaft wall to a greatly reduced extent. In other words, this means that the self-adhesive element or the adhesive is vibration-insulating or has a vibration-insulating effect.

A development of the method comprises the following additional method step: applying the adhesive layer after the rail bracket has been prefixed to the shaft wall. Accordingly, the adhesive layer is applied after the component has been prefixed to the shaft wall. The component is prefixed to the shaft wall by means of the self-adhesive element without the adhesive layer, provided for curing, being arranged on the contact surface of the component or on the fixing region of the shaft wall when the component is attached. By applying the adhesive layer immediately afterward, the component is fixed, or fixed by curing of the adhesive layer, to the shaft wall. It is advantageous that a contact surface or fixing region which are not provided with an adhesive layer to be cured until the component is attached to the shaft wall makes it possible for the adhesive layer not to cause weaker fixing of the component to the shaft wall by, for example, flowing away.

The adhesive may be applied to the second part of the contact surface through a through-hole of the component that penetrates the contact surface. In a corresponding development of the elevator system, the component has at least one through-hole which penetrates the contact surface in order to apply the adhesive layer or in order to visually monitor a space between the contact surface of the component and the fixing region of the shaft wall. Accordingly, the adhesive can be applied to the second part of the contact surface through the through-hole. Such a through-hole makes it possible to introduce the adhesive provided for the adhesive layer between the second part of the contact surface and the fixing region when the component is already prefixed to the shaft wall. For example, this through-hole can be closed after the adhesive has been introduced in order to prevent the adhesive from leaking out of the region provided for the adhesive.

Accordingly, the adhesive layer can be applied by means of an adhesive pump. Advantageous application of the adhesive through the through-hole onto the second part of the contact surface is made possible by means of such an adhesive pump. Such an adhesive pump can be designed in the form of a glue gun and also have a flexible hose which can be guided into the through-hole in order to be able to introduce the adhesive into the space between the contact surface and the fixing region.

The through-hole can be designed, for example, as a filler neck or as a filler valve. The through-hole is therefore suitable, for example, for introducing the flexible hose in order to be able to pour the adhesive into the space between the contact surface and the fixing region of the shaft wall.

Filling the space between the contact surface and the fixing region of the shaft wall requires a defined amount of adhesive. Correspondingly, the adhesive pump can be provided with a dosing element, in particular a scale, which dosing element makes it easier to maintain a predetermined amount of adhesive when filling the space between the contact surface and the fixing region.

In a development of the elevator system, the self-adhesive element has a thickness, extending perpendicularly to the shaft wall, of from 0.5 to 10 mm, preferably 0.5 to 3 mm. By means of such a specification of the thickness of the self-adhesive element, it is possible to determine the thickness of the adhesive layer which is applied to the second part of the contact surface or the fixing region of the shaft wall that corresponds to the second region of the contact surface from the outset and accordingly the adhesive properties of the component on the shaft wall in the cured state of the adhesive layer.

A further aspect of selecting the thickness of the self-adhesive element results from the viscosity properties of the adhesive to be poured between the contact surface of the component and the fixing region of the shaft wall. This applies in particular to the case already mentioned, in which the adhesive is applied to the shaft wall after the component has been prefixed. According to the predetermined distance, the adhesive can flow between the shaft wall and the contact surface.

In a development of the elevator system or the method, the first part of the contact surface is formed in an edge region of the contact surface or the self-adhesive element is applied in an edge region of the contact surface. The second part of the contact surface is preferably arranged inside the first part of the contact surface. Forming the first part of the contact surface in the edge region of the contact surface and then applying the self-adhesive element in this edge region makes it possible to prevent the adhesive from leaving the fixing region of the shaft wall during the time it takes for the adhesive to cure.

As an alternative to this, the second part of the contact surface is formed in the edge region and, as a result, the first part of the contact surface is formed inside the second part of the contact surface. Therefore, after prefixing, the adhesive layer is to be introduced between the shaft wall and the edge region. This introduction can take place along the outer edge of the contact surface.

In a development of the elevator system, the self-adhesive element has at least one break in the edge region. When the adhesive layer is applied after the component has been prefixed to the shaft wall, such breaks make it possible for the air present between the contact surface of the component and the fixing region of the shaft wall to be displaced by the adhesive introduced. For the same purpose, the self-adhesive element can alternatively or additionally be porous.

Such a break is preferably at a maximum distance from the through-hole for applying the adhesive. If the first part of the contact surface has corners, for example, the break can accordingly be arranged in the corner of the first part of the contact surface that is furthest away from this through-hole. If the adhesive flows through this break when the adhesive is applied to the second part of the contact surface, the person applying the adhesive can see that the space between the contact surface and the fixing region is filled with adhesive.

### DESCRIPTION OF THE DRAWINGS

The invention is explained in more detail below with reference to the figures and the following detailed description of various embodiments. In the drawings:

FIG. 1: shows an elevator system having guide rails arranged along the elevator shaft;

FIG. 2: shows a component, which is fixed to a shaft wall, of the elevator system shown in FIG. 1;

FIG. 3: shows a detail of FIG. 2;

FIG. 4: shows a contact surface of the component provided with a self-adhesive element according to a first embodiment;

FIG. 5: shows a contact surface of the component provided with a self-adhesive element according to a second embodiment; and

FIG. 6: shows a contact surface of the component provided with a self-adhesive element according to a third embodiment.

### DETAILED DESCRIPTION

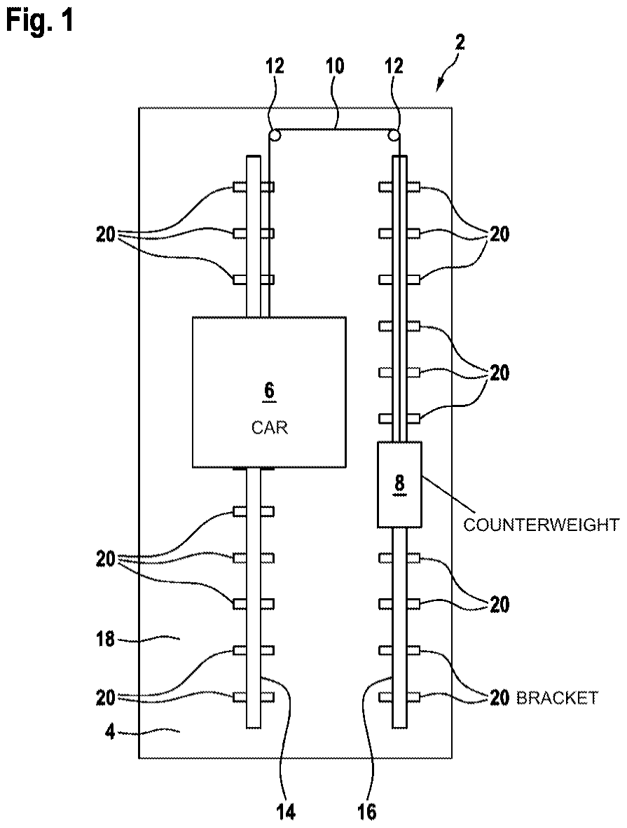

FIG. 1 shows a schematic representation of an elevator system 2 comprising an elevator shaft 4. The elevator system 2 comprises an elevator car 6 and can comprise a counterweight 8, with the elevator car 6 being arranged such that it can be moved along the elevator shaft 4. The elevator car 6 and the counterweight 8 are connected by means of a suspension element 10. The suspension element 10 is guided in a shaft head of the elevator shaft 4 via deflection rollers 12. For example, one of these deflection rollers 12 can be designed as a drive roller of a drive unit of the elevator system 2.

If the counterweight 8 is present, the elevator car 6 and the counterweight 8 are therefore arranged to be movable in opposite directions within the elevator shaft 4. Guide rails 14, 16 for guiding the elevator car 6 or the counterweight 8 in the elevator shaft 4 are arranged along the movement path of the elevator car 6 or the counterweight 8. The elevator system 2 usually comprises two guide rails 14 for guiding the elevator car 6 or two guide rails 16 for guiding the counterweight 8.

Each of these guide rails 14, 16 usually comprises a plurality of short guide rail segments which, when fixed in a row on a shaft wall 18 of the elevator system 2, form the corresponding guide rail 14, 16. The guide rails 14, 16 extend along the movement path of the elevator car 6 and the counterweight 8. Therefore, the guide rails 14, 16 usually extend substantially along the entire extent of the elevator shaft 4. Each of the guide rails 14, 16 or each of their guide rail segments is fixed to the shaft wall 18 by means of a large number of rail brackets 20.

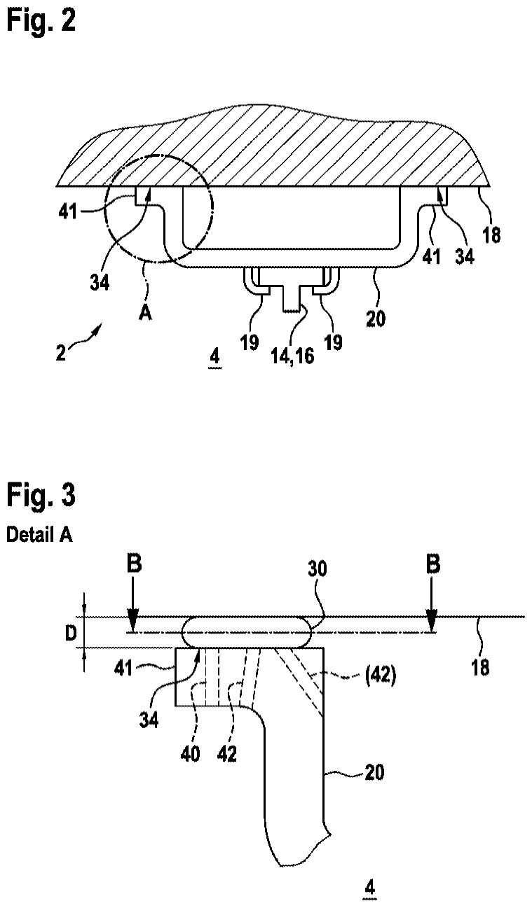

FIG. 2 shows a component, in particular such a rail bracket 20, of the elevator system 2 in cross section when it is fixed to the shaft wall 18. The guide rail 14, 16 can be fixed to this rail bracket 20 by means of fixing clips 19 provided for this purpose. The rail bracket 20 usually comprises at least two contact surfaces 34 for fixing the rail bracket 20 to the shaft wall 18. Each of these contact surfaces 34 is arranged on a rail bracket foot 41.

For example, such a rail bracket 20 can be fixed to the shaft wall 18 manually or by machine. In the case of machine fixation, the use of assembly devices is suitable. Such an assembly device is disclosed by way of example in WO2019063356. Such assembly devices prepare the elevator shaft 18 for the installation of further constituents of the elevator system 2.

FIG. 3 shows a detail A which was indicated in FIG. 2. A portion of the rail bracket 20 which has one of the at least one contact surfaces 34 and is fixed to the shaft wall 18 is shown. A self-adhesive element 30 is arranged between the contact surface 34 and the shaft wall 18. The self-adhesive element 30 has a dimension denoted as thickness D perpendicular to the surface of the shaft wall 18. By means of this thickness D of the self-adhesive element 30 which is used to prefix the rail bracket 20, a strength of the adhesive layer can be predetermined, which strength of the adhesive layer also corresponds to the dimension D.

The rail bracket foot 41 of the rail bracket 20 can have at least one through-hole 40, 42. The through-hole 40, 42 penetrates the rail bracket foot 41 and thus the contact surface 34 in such a way that the adhesive can be introduced into a space between the contact surface 34 and a fixing region of the shaft wall 18 when the rail bracket 20 is prefixed, or in such a way that it is possible for this space to be monitored. By means of this monitoring, when this space is filled with adhesive, it is possible to see whether or when enough adhesive has been introduced into the space.

The rail bracket foot 41 preferably has a first through-hole 40 which is adapted for applying the adhesive to the contact surface 34. The through-hole 40 is in particular adapted for introducing the adhesive into the space between the contact surface 34 and the fixing region of the shaft wall 18 by means of an adhesive pump.

Additionally or alternatively, the rail bracket foot 41 can have at least one through-hole 42 for visually monitoring the space between the contact surface 34 and the fixing region of the shaft wall 18 and/or for ventilating this space when the adhesive layer is applied. Accordingly, the air can be displaced into the interior of the elevator shaft 4 by applying the adhesive layer.

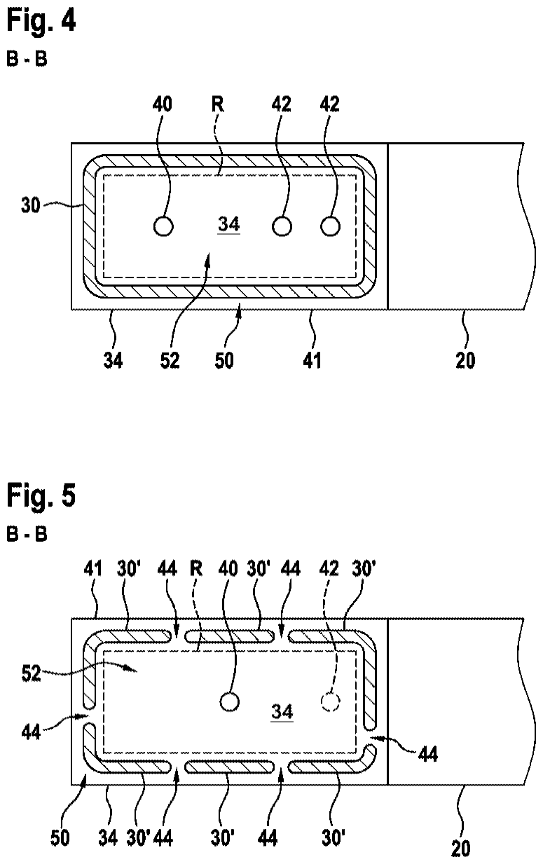

FIGS. 4 to 6 each show an embodiment according to a section B-B indicated in FIG. 3. The contact surface 34 of the rail bracket foot 41 is essentially shown as a constituent of the rail bracket 20. The contact surface 34 has a first part 50 and a second part 52. The first part 50 is provided for applying the self-adhesive element 30, 30′ which is provided for the prefixing. For example, the self-adhesive element 30, 30′ can be fixed to the fixing region of the shaft wall 18 and the rail bracket 20 can be pressed against the fixing region for prefixing, so that prefixing of the self-adhesive element 30, 30′ can take place. As an alternative to this, the self-adhesive element 30, 30′ can be fixed to the rail bracket 20 prior to being prefixed to the shaft wall 18.

The second part 52 is provided for applying the adhesive layer which is provided for curing and thus for the final fixing of the rail bracket 20 to the shaft wall 18. The first part 50 of the contact surface 34 is preferably formed in an edge region R of the contact surface 34. The second part 52 of the contact surface 34 is preferably formed inside the first part 50 of the contact surface 34.

The self-adhesive element 30 shown in FIG. 4 is formed continuously in the first part 50 formed along the edge region R. The self-adhesive element 30 formed continuously in the edge region can be porous in order to ventilate the space formed between the contact surface 34 and the fixing region of the shaft wall.

According to the embodiment shown in FIG. 4, the rail bracket foot 41 has at least one through-hole 42 for ventilating the space between the contact surface 34 and the fixing region of the shaft wall as well as the porous self-adhesive element 30 described above. It is also possible, for example, for such a self-adhesive element 30 having porosity to be used as an alternative to the through-hole 42 provided for ventilating the space between the contact surface 34 and the fixing region of the shaft wall 18.

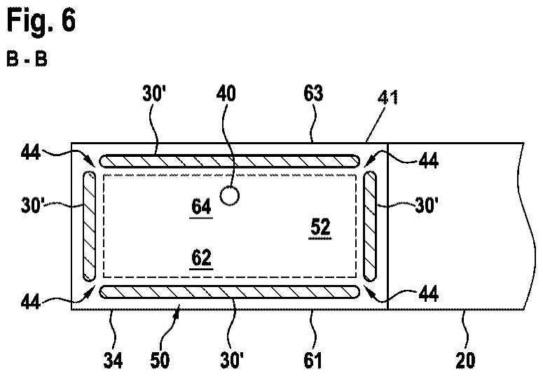

The self-adhesive element 30′ shown in FIGS. 5 and 6 has breaks 44. Such breaks 44 in the self-adhesive element 30′ can be formed alternatively or in addition to the at least one through-hole 42 for ventilating the space between the contact surface 34 and the fixing region of the shaft wall 18 or the self-adhesive element 30′ having porosity.

According to FIG. 5, the breaks 44 can be distributed along the edge region R. According to the embodiment shown in FIG. 6, the contact surface 34 has an upper region 64 and a lower region 62. The upper region 64 is delimited directly on one side by an upper edge 63 and the lower region 62 is delimited directly on one side by a lower edge 61.

This lower edge 61 faces from the contact surface 34 in the direction of the bottom of the elevator shaft 4, and the upper edge 63 faces from the contact surface 34 in the opposite direction, preferably toward a shaft head of the elevator shaft 4. The through-hole 40 for applying the adhesive layer is arranged in the upper region 64 of the contact surface 34 so that filling the first part 52 with adhesive results in the adhesive flowing from the upper region 64 into the lower region 62 according to force of gravity. The through-hole 40 is preferably arranged largely centrally between the lateral boundaries of the first part 52 of the contact surface 34.

The breaks 44 shown in FIG. 6 are preferably arranged at the corners of the contact surface 34 or of the edge region R. This results in the largest possible distance between the breaks 44 for ventilating the space between the contact surface 34 and the fixing region of the shaft wall 18.

Correspondingly, if the component has previously been prefixed to the shaft wall 18, adhesive flows through the breaks 44 only when the space between the contact surface 34 and the fixing region of the shaft wall is largely filled with adhesive. Thus, if the adhesive flows out of the at least one break, it can be used as a criterion for stopping the application of the adhesive.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for fixing a component to a shaft wall of an elevator system, the component being a rail bracket adapted for fixing a guide rail inside the elevator system, wherein the rail bracket has a contact surface for flat fixing of the rail bracket to the shaft wall, the method comprising the following steps:
prefixing the rail bracket to the shaft wall by a self-adhesive element attached or applied to a first part of the contact surface; and
applying a curing adhesive in a layer to a second part of the contact surface, the adhesive layer being arranged between the contact surface and a fixing region of the shaft wall when the rail bracket is fixed to the shaft wall.

17. The method according to claim 16 including applying the self-adhesive element in an edge region of the contact surface.

18. The method according to claim 16 including applying the adhesive layer after the rail bracket has been prefixed to the shaft wall.

19. The method according to claim 18 including applying the adhesive layer to the second part of the contact surface through a through-hole of the rail bracket that penetrates the contact surface.

20. The method according to claim 19 including applying the adhesive layer using an adhesive pump.

21. An elevator system having a shaft wall, the elevator system comprising:
a component fixed to the shaft wall, the component being a rail bracket adapted to fix a guide rail of the elevator system to the shaft wall, wherein the rail bracket has a contact surface for flat fixing of the rail bracket to the shaft wall and the contact surface has two parts;
a self-adhesive element arranged in the first part between the contact surface and a fixing region of the shaft wall; and
an adhesive layer arranged in the second part of the contact surface whereby the rail bracket is fixed to the shaft wall.

22. The elevator system according to claim 21 wherein the self-adhesive element has a thickness in a range of 0.5 to 10 mm extending perpendicularly to the shaft wall.

23. The elevator system according to claim 21 wherein the self-adhesive element has a thickness in a range of 0.5 to 3 mm extending perpendicularly to the shaft wall.

24. The elevator system according to claim 21 wherein the first part of the contact surface is formed in an edge region of the contact surface.

25. The elevator system according to claim 24 wherein the self-adhesive element has at least one break in the edge region.

26. The elevator system according to claim 21 wherein the second part of the contact surface is formed within the first part of the contact surface.

27. The elevator system according to claim 21 wherein the self-adhesive element is porous.

28. The elevator system according to claim 21 wherein the rail bracket has at least one through-hole that penetrates the contact surface to enable application of the adhesive layer or to visually monitor a space between the contact surface and the fixing region of the shaft wall.

29. A rail bracket adapted to be fixed to a shaft wall of an elevator system, wherein the rail bracket has a contact surface for flat fixing of the rail bracket to the shaft wall and the contact surface has a first part for applying a self-adhesive element, the self-adhesive element being adapted for prefixing the rail bracket to the shaft wall, wherein the contact surface has a second part adapted for applying an adhesive thereto, wherein the second part has at least one through-hole formed therein to enable application of the adhesive and/or to visually monitor a space between the contact surface and a fixing region of the shaft wall as the rail bracket is fixed to the shaft wall.

30. The rail bracket according to claim 29 wherein the at least one through-hole is formed as a filler neck or as a filler valve.

31. The rail bracket according to claim 29 wherein the rail bracket has the self-adhesive element applied to the first part.
